(19) United States
(12) Patent Application Publication
(10) Pub. No.: US 2026/0093996 A1
(43) Pub. Date: Apr. 2, 2026

(54) SYSTEMS AND METHODS FOR TRAINING LANGUAGE MODELS WITH AUTOMATIC CURRICULUM

(71) Applicant: Salesforce, Inc., San Francisco, CA (US)

(72) Inventors: Amrita Saha, Singapore (SG); Caiming Xiong, Menlo Park, CA (US); Doyen Sahoo, Singapore (SG); Hanze Dong, San Francisco, CA (US); Zirui Zhao, San Francisco, CA (US)

(21) Appl. No.: 19/043,137

(22) Filed: Jan. 31, 2025

Related U.S. Application Data
(60) Provisional application No. 63/700,412, filed on Sep. 27, 2024.

(51) Int. Cl. G06N 3/091

(52) U.S. Cl. CPC G06N 3/091

(57) ABSTRACT

Embodiments described herein provide a method for training a neural network based language model (LM), comprising: receiving a training dataset including pairs of queries and ground-truth responses; performing a training iteration using a reward based on response length with respect to a tunable value when the predicted response refuses to respond to a query; automatically modifying the tunable value; and repeating the training iteration with the modified tunable value.

The instant application is a nonprovisional of and claim priority under 35 U.S.C. 119 to U.S. provisional application No. 63/700,412, filed Sep. 27, 2024, which is hereby expressly incorporated by reference herein in its entirety.

### TECHNICAL FIELD

The embodiments relate generally to machine learning systems for neural network based language models, and more specifically to systems and methods for training language models with automatic curriculum.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Hallucination is a long-standing issue in large language model (LLM) research, which refers to the phenomenon where LLM-generated content appears plausible but is actually nonsensical or inaccurate, often misleading humans by seeming deceptively credible. It is more evident when solving complex reasoning problems beyond their capability, in which LLM tends to fake evidence or logic to answer the questions assertively. The reason for LLM's hallucinations, overall, is a misalignment of its real capability and its behaviors: LLM should not behave overly assertively or confidently when facing unfamiliar and difficult problems. Instead, a preferred behavior of LLMs is to acknowledge their incapability and say, “I don't know,” but only in when the question falls within the boundary of its capability. Thus, a reliable LLM must have a reasonable balance between maximizing its capability and avoiding hallucination. Current efforts to reduce hallucinations primarily focus on factual errors in knowledge-grounded tasks, often neglecting hallucinations related to faulty reasoning. Meanwhile, some approaches render LLMs overly conservative, limiting their problem-solving capabilities

Therefore, there is a need for systems and methods for LLM training for reliable reasoning.

### BRIEF DESCRIPTION OF THE DRAWINGS

FIG. 1 is a simplified diagram illustrating a language model training framework according to some embodiments.

FIG. 2 is a simplified diagram of a curriculum for a language model training framework according to some embodiments.

FIG. 3 is an exemplary reward shaping function utilized in a language model training framework according to some embodiments.

FIG. 4 is an algorithm for expert iteration according to some embodiments.

FIG. 5 is an automatic curriculum algorithm according to some embodiments.

FIG. 6A is a simplified diagram illustrating a computing device implementing the language model training framework described in FIGS. 1-5, according to some embodiments.

FIG. 6B is a simplified diagram illustrating a neural network structure, according to some embodiments.

FIG. 7 is a simplified block diagram of a networked system suitable for implementing the language model training framework described in FIGS. 1-6B and other embodiments described herein.

FIG. 8 is an example logic flow diagram illustrating a method of training a neural network based language model based on the framework shown in FIGS. 1-7, according to some embodiments.

FIGS. 9-13 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

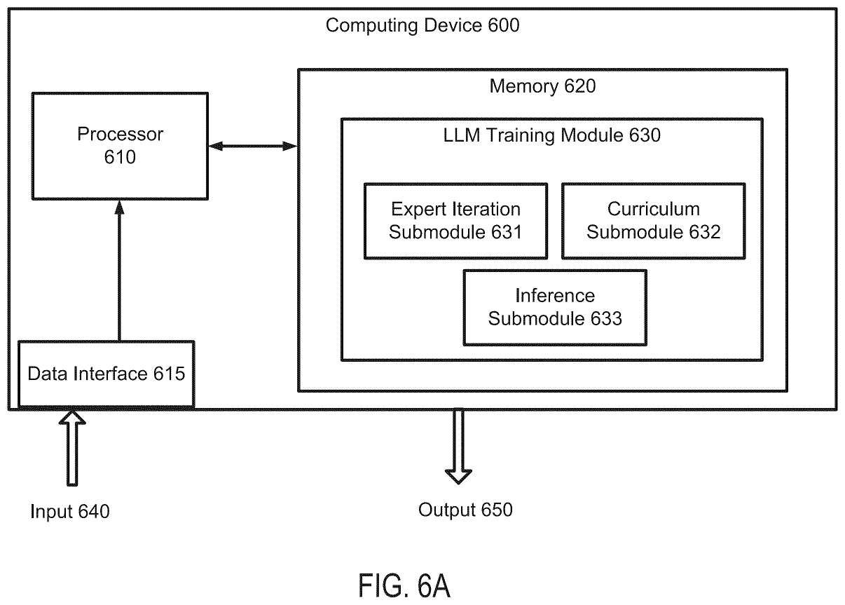

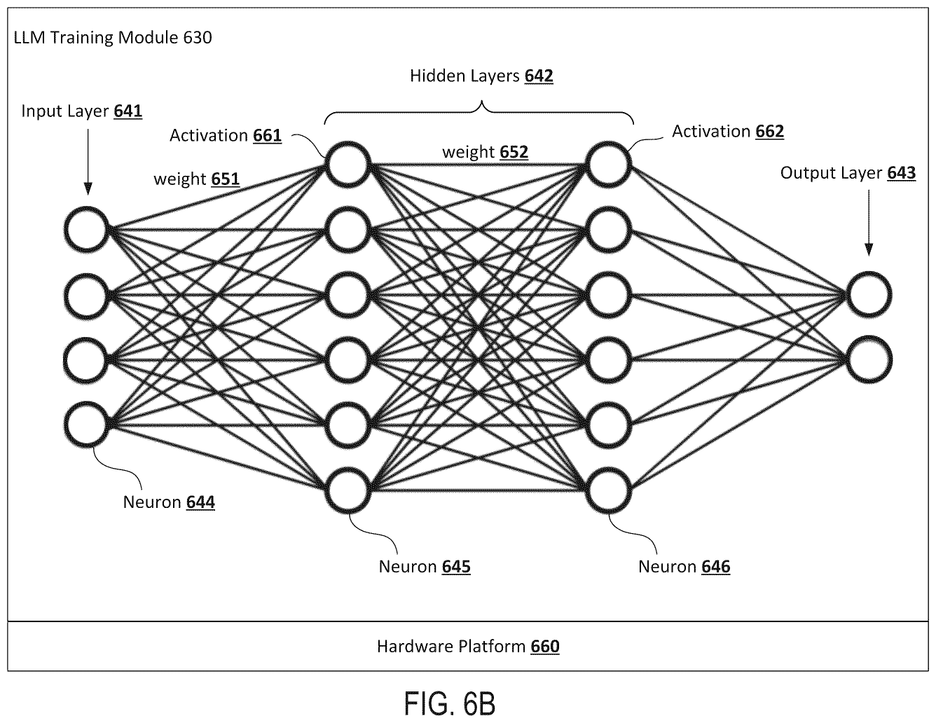

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

Large Language Models (LLMs) may be used to complete a variety of tasks by giving the LLM an appropriate instruction (referred to as a “prompt”), including answering questions. Hallucinations (i.e., generating plausible but inaccurate content) and laziness (i.e., excessive refusals or defaulting to “I don't know”) persist as major challenges in LLM reasoning.

In view of the need for systems and methods for LLM training for reliable reasoning, embodiments herein include a training framework for an LLM to make a decision whether to generate an answer to a question so as to balance laziness and hallucinations. A training dataset is provided with queries and ground-truth responses. The LLM is provided a query from the training dataset and generates a number of responses to the query at multiple inference instances. A reward function is used to compute a reward for each of the responses. The computed reward for a given query/response pair is used in sampling the training data for supervised fine-tuning. In this way, the LLM is trained with the sampled training data reflecting the “reward” of the query response pair, so as to balance the likelihood of different types of responses.

The reward function is shaped such that an asserted incorrect response receives a score of −1, an asserted correct response receives a score of +1, and an “I don't know” answer receives a score based on a curve related to the length of the response, parameterized by a parameter c1. Refusal responses with lengths larger than the value of c1 receive a positive reward, and refusal responses with lengths shorter than the value of c1 receive a negative reward. The value of c1 is automatically changed each iteration of training. By increasing c1, the LLM is encouraged to generate longer responses before indicating an “I don't know” response.

It is widely acknowledged that LLMs often produce hallucinated responses, including fabricated facts and misleading logic. Most works focus on reducing hallucinations by ensuring the factual accuracy of generated content, often using retrieval-based methods that enhance LLMs with external knowledge. Retrieval-based strategies show strong potential in mitigating hallucinations, outperforming purely generative models that rely only on knowledge from training. However, hallucinations are not limited to factual inaccuracies; they can also extend to faulty or incomplete reasoning, a significant concern for multi-step reasoning-based tasks. Moreover, LLMs often exhibit what can be described as “laziness,” which refers to the tendency of the model to reject or avoid generating correct but complex answers in favor of simpler, superficial, or incomplete responses. This phenomenon has been noted in tasks requiring step-by-step logical reasoning, where LLMs tend to skip intermediate steps or provide too general answers, rather than addressing the nuanced complexity of the problem at hand.

Embodiments described herein provide a number of benefits. For example, as compared with alternative LLM training methods across logical reasoning, mathematics, and planning tasks, embodiments described herein achieve superior alignment by effectively balancing assertiveness and conservativeness. The improved responses increase the effectiveness of the LLM in various use cases. For example, as integrated into an AI agent system, the improved LLM performance allows for more reliable AI agent behaviors. In cases where the LLM is unable to provide a response, an AI agent may prompt a user indicating the request was beyond the capability of the system. For requests which the system is capable of performing, more confidence may be put into the system to provide correct responses and behaviors. In the context of auto-complete (e.g., for code generation), in the case an LLM is not able to provide a response (i.e., provides an “I don't know” response), the system may not display a suggested auto-complete suggestion. The improved reliability further allows for the LLM to be used in multi-step reasoning problems, as an unreliable LLM causes excessive errors to accumulate over multiple steps. Therefore, with improved performance on reliable reasoning, neural network technology in training of LLMs for AI agents, code generation, chat agents, question answering, multi-step reasoning, and others is improved.

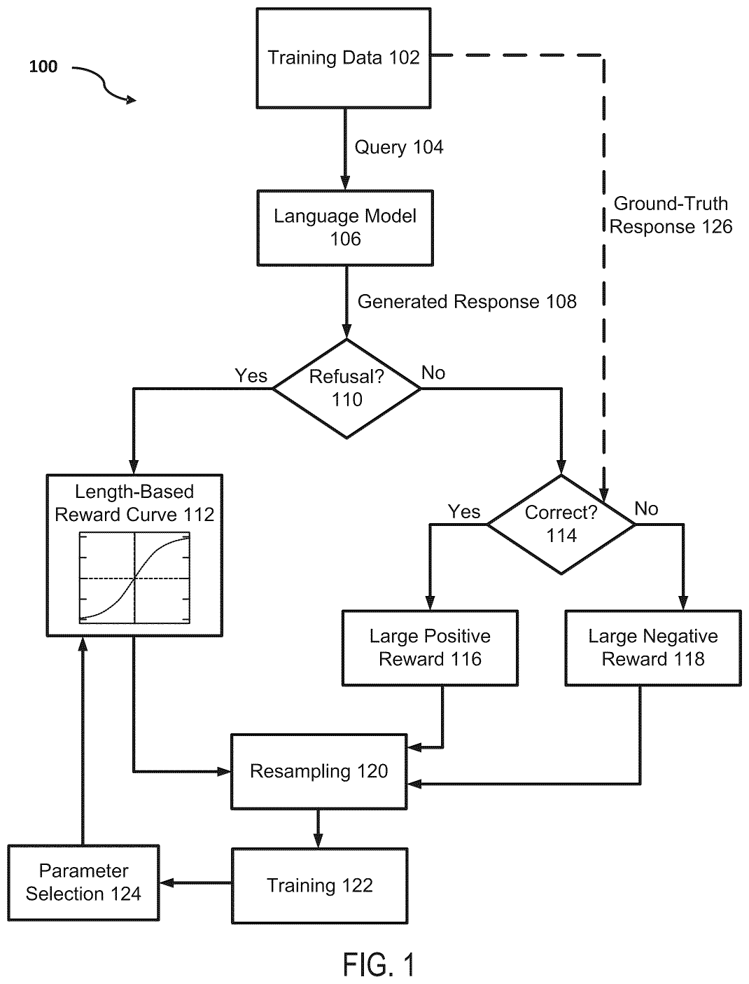

FIG. 1 is a simplified diagram illustrating a language model training framework 100 according to some embodiments. Framework 100 incudes a language model 106 that is being trained. In some embodiments, to capture reasoning problems, language model 106 relies on planning concepts that consist of four main elements: state space S, action space A, transition function T, and goal function G. The state space S includes all possible configurations, such as the boolean or scalar values assigned to the given variables or clauses, as well as unknown clauses. Actions, defined in the action space A, represent rules or equations that can be applied to these states. The action has its preconditions and effects. A state should satisfy the corresponding precondition to execute an action, and then the effects will be applied to the state. The precondition and effect are encoded in the transition function. When an action A is executed in a state S, the transition function T(s,a) determines the resulting states, e.g., new values would be assigned to (unknown) clauses or variables. The goal function G checks whether the current state matches the desired outcome. Under this framework language model 106 may perform iterative reasoning. Language model 106 may be pretrained using a number of methods, including supervised fine-tuning (SFT).

SFT may be used to pre-train a language model 106 given the training dataset D consisting of n question-answer pairs. Each answer may use a chain of thought. In some embodiments, after SFT, language model 106 answers the questions in the same dataset D using random sampling. As random sampling is used, there will be a certain number of correct answers, and the others will be wrong. The questions and the new answers generated by LLM may be split into two datasets, D1 and D2, where D1 collects correct answers and D2 consists of wrong answers. For D2, in each of the wrong answers, an expression may be added at the end to acknowledge the limitations and abstain from answering the questions, such as “Sorry, I am not sure if I answer the question correctly. There might be mistakes in my answer.” In this way a Refusal-Aware dataset D2 is generated for SFT.

After collecting D₁ and D₂, both datasets may be concatenated to form Dᵢₙᵢₜ and use SFT to fine-tune the LLM again. In some embodiments, the SFT result may be examined to ensure it has enough sample points for assertive and refusal answers. For example, a threshold of 25% may be set for the distribution of refusal behaviours in the validation set, as the training data needs to have enough variety of acknowledge “I don't know” responses. If the model has a very low distribution of acknowledge “I don't know”, the previous process of collecting D₁ and D₂ may be performed again, where the refusal answers will also be collected in D₁ and use the new dataset for a new SFT training. This pre-training ensures that the language model 106 provides a sufficient amount of refusal responses for framework 100 to be successful.

After pre-training (which may or may not include the SFT pre-training described above), framework 100 may be used to further fine-tune language model 106. Training data 102 may be provided which includes queries and ground-truth responses. Language model 106 (e.g., an LLM) may generate a generated response 108 based on a query 104 from the training data 102. Language model 106 may be configured to generate chain-of-thought responses including multiple reasoning steps. This may be performed by allowing the language model 106 to generate “thoughts” which are used in prompting the language model 106 subsequently and repeat until the language model 106 generates a response or a refusal.

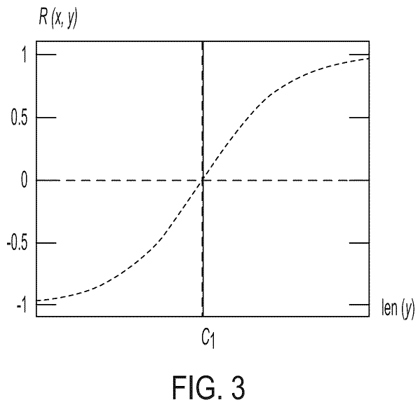

At decision 110, the system determines if generated response 108 is a refusal (e.g., “I don't know”). If generated response 108 is a refusal, then the reward score is determined based on length-based reward curve 112. Length-based reward curve 112 is parameterized, and may be configured so that refusal responses with lengths (e.g., number of reasoning steps) greater than a tunable value are given positive rewards, and refusal responses with length less than the tunable value are given negative rewards. The exact value may be determined based on a curve as described in FIG. 3.

If generated response 108 is not a refusal, then the reward depends on whether or not the generated response 108 is correct. At decision 114, the system determines whether the non-refusal generated response 108 is correct based on ground-truth response 126 from training data 102. In some embodiments, the correctness is determines based on whether generated response 108 is an exact match to ground-truth response 126. In some embodiments, a more forgiving metric for correctness is utilized. For example another language model may be provided both the generated response 108 and the ground truth response 126 and prompt the language model to indicate if the two responses have substantially the same semantic meaning.

If generated response 108 is correct, then it receives a large positive reward 116 (e.g., a reward value of 1 in a scale of −1 to 1). If generated response 108 is not correct, then it receives a large negative reward 118 (e.g., a reward value of −1 in a scale of −1 to 1). The determined reward (whether from length-based reward curve 112, large positive reward 116, or large negative reward 118) may be used for resampling 120.

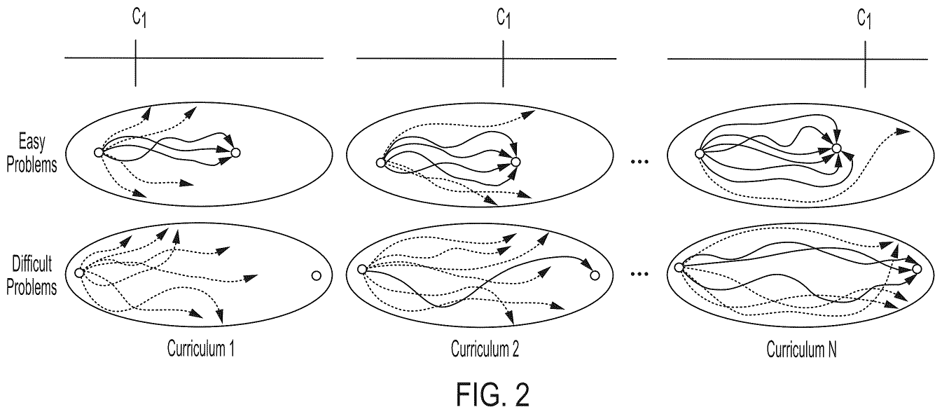

Resampling 120 may sample pairs of queries 104 and generated responses 108 with a probability according to their determined score. Training 122 may train the language model 106 the sampled training pairs. After a round of training (which may include training on multiple query/response pairs, and/or training until the language model 106 converges using the current reward parameters), parameter selection 124 may be used to update one or more parameters for length-based reward curve 112. Training may continue via multiple iterations of generating responses, determining rewards, resampling, and training, followed by updating parameters of the reward curve 112. The updating of reward parameters during the training process represents a curriculum which is used to automatically adjust over the course of training. Additional description of updating of parameters are described with respect to FIGS. 2-3.

The above framework 100 may, in some embodiments, be described as follows. Language model 106 generates K samples {yᵢ} (for i 1:K) for each of the questions in the training dataset D. Then, the reward function is used to get a reward value of each sample r₁, r₂, . . . , r_{K}. Over that reward, a temperature-scaled softmax function may be used to construct a new distribution: p′(yᵢ)=exp(rᵢ/τ)/Σj exp(rⱼ/τ) and subsequently use p′(yᵢ) to conduct resampling and generate N new samples {y′ᵢ}. τ is the temperature of resampling, the same as the overall accuracy of the initial SFT model finetuned by D. If the SFT model has high overall accuracy, language model 106 is encouraged to explore more randomly; otherwise, the responses with higher rewards will be sampled more densely. In some embodiments, τ will be capped in a range [0.4, 0.7] to avoid extreme cases. Thus, the distribution is reshaped to encourage more instances that produce correct answers and produce more reasoning steps before saying “I don't know.” Since resampling also kills instances that waste some of the exploration data, {yi} and {y′ᵢ} may be concatenated together to form the new training dataset. Lastly, answers that have −1 rewards may be removed.

After the training converges with the current reward parameters, the curriculum updates the reward function to optimise (i.e. maximize) an objective function. In some embodiments, the objective function is:

$$f = ( 1 - λ ) {P}_{Pre} + λ ( 1 - {P}_{IDK} ) \qquad ( 1 )$$

where P_{Pre} denotes the precision, i.e., the correctness of answers that are not refusal answers, and P_{IDK} denotes the proportion of refusal answers. This function ƒ tries to find a good balance between avoiding both hallucination (low P_{Pre} and low P_{IDK}) and laziness (high P_{Pre} but high P_{IDK}) when finetuning the language model 106. λ∈[0,1] is a hyperparameter to control the tradeoff between hallucination and laziness; a higher value of λ will lead to more assertive behaviour (i.e. lower IDK rate) while smaller λ would make the LLM policy behave more conservatively. In most task scenarios, setting λ to a reasonably small value (≈0.2) achieves the desired effect for the language model 106 policy. Over the training iterations, the curriculum will update the reward parameters (e.g., as described in FIGS. 2-3) to encourage more exploration before saying “I don't know”. Thus, with the new reward function, training is repeated and made to converge again.

Assuming that the function of ƒ does not have local optimal point with respect to c₁, the curriculum uses local search (hill climbing) to search c₁ and conduct Expert Iterations until it finds the highest ƒ. The hill-climbing algorithm searches its neighbouring value of c_1∓d via a step size d, and iff at the new step is higher, then it updates c₁ to the new value. It will stop the search if its neighbouring c₁ has a smaller value than its current ƒ. The domain of c₁ may be [μ−2σ,μ+2σ] where μ denotes the average length of the reasoning steps produced by the initial LLM policy. This provides an upper and lower bound on values it may take. Step size d may in some embodiments be defined by:

$$Min ( 0.5 , 4 σ / 10 ) \qquad ( 2 )$$

where σ denotes the standard deviation of the reasoning length produced by the initial LLM policy. By taking the minimum of 4σ/10 and 0.5, this keeps the step size from getting too large, capping it by a threshold value of 0.5, an empirically selected value which may be different in some embodiments.

FIG. 2 is a simplified diagram of a curriculum for a language model training framework according to some embodiments. FIG. 2 illustrates how an LLM may behave during training with varying parameter values on both easy and difficult problems. The dashed lines represent LLM reasoning which does not reach an answer (IDK), and therefore provides a refusal response. Solid lines represent LLM reasoning which does reach an answer. The relative length on the horizontal axis of a line represents the relative length (e.g., number of reasoning steps) that the LLM takes before giving a refusal or stating an answer. As illustrated, for an early curriculum step (e.g., curriculum 1), the parameter value c₁ is set to a relatively lower value. In this way, the LLM receives a positive reward for a refusal response even with relatively short responses. As training continues, the value of c₁ generally increases as shown in curriculum 2 and curriculum 3. The LLM is thereby only rewarded for refusal answers after longer and longer response lengths.

The key idea of this curriculum framework is using the length of reasoning steps to measure difficulty, the curriculum rewards correct reasoning, compensates for “I don't know” acknowledgements after a sufficient number of attempts, and penalizes both overly conservative and assertive wrong responses. The training framework 100 adjusts the LLM's responses by resampling based on these rewards. The curriculum automatically updates the compensation reward to encourage more reasoning attempts before saying “I don't know” over time. It gradually adjusts the reward function to optimize an objective function, balancing the overall precision and the proportion of saying “I don't know” to control hallucination and avoid laziness. As such, it gradually pushes the limits to maximize the potential of LLM reasoning and aligns its behaviors with these limits. This curriculum is effective across various reasoning tasks such as logical, mathematical, and planning problems, balancing reliability and conservativeness.

This training framework represented in FIGS. 1-2 and elsewhere herein simultaneously enhances LLM reasoning and aligns its behavior to ensure precise answers while acknowledging its limitations. Framework 100 assumes that the number of reasoning steps required to reach a correct answer provides a reasonable estimate of both the problem difficulty and the limits of LLM reasoning. This assumption is grounded in computational theory, as each reasoning problem has its underlying computational complexity, and each reasoning step corresponds to an elementary computing operation. Learning the reasoning steps (precondition/effect of reasoning rules) has similarly low sample complexity. Despite the existence of concise optimal solutions, difficult problems (e.g., NP-complete problems) require extended reasoning to find those solutions. This assumption helps align LLM's behaviors: easier problems require fewer reasoning steps and are less prone to compounding errors, justifying greater assertiveness from LLMs. Complex problems needing more steps and suffering more compounding errors require more conservativeness.

The curriculum automatically estimates the boundary of its reasoning capacity, thus achieving a reasonable alignment to maximize capacity and control behaviors. It learns to reliably solve the problems within its boundary as much as possible; it also knows to acknowledge “I don't know” when the problem is beyond its limit.

FIG. 3 is an exemplary reward shaping function utilized in a language model training framework according to some embodiments. For a refusal response, as describe in FIGS. 1-2, a reward is generated based on the length of the response. In some embodiments, the shape of the reward is a curve generated by the following equation:

$$R ( x , y ) = \frac{1 - exp ( {c}_{2} ( len ( y ) - {c}_{1} ) )}{1 + exp ( {c}_{2} ( len ( y ) - {c}_{1} ) )} \qquad ( 3 )$$

where x is the query, and y is the response.

In equation (3), c1 and c2 are two hyperparameters determined by the distribution of answers from the initial LLM. If y is a refusal answer and the number of steps for the reasoning trajectory len(y) is longer than c₁, then it will receive a small positive compensation reward; otherwise, it turns into a small negative penalty. The shape of this function is illustrated in FIG. 3. In some embodiments, c₁ is initialised by the mean value of reasoning steps produced by the initial LLM policy in the validation set. In some embodiments, c₂ is computed by solving the following equation:

$$\frac{1 - exp ( - {c}_{2} \cdot 2 σ )}{1 + exp ( - {c}_{2} \cdot 2 σ )} = 0.9 \qquad ( 4 )$$

meaning that if the number of reasoning steps has reached c₁+2σ (σ is the standard deviation of the reasoning steps by initial policy), then the reward should be higher than 0.9. In some embodiments, values other than 0.9 may be used. Based on equation (4), the answer is longer than roughly 97% of the reasoning trajectories in the validation set, assuming the distribution of reasoning steps is a normal distribution.

While equation (2) represents the reward function for a refusal response, the overall reward function of a response may be considered to include a positive value (e.g., 1) for a correct non-refusal response, and a negative value (e.g., −1) for an incorrect non-refusal response as described in FIG. 1.

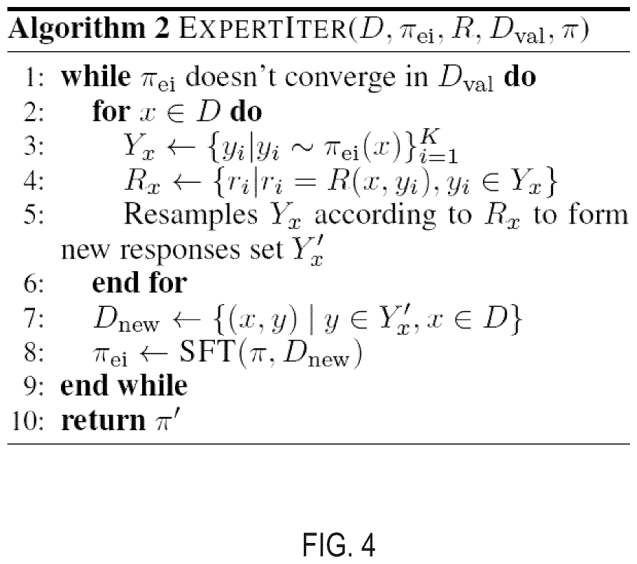

FIG. 4 is an algorithm for expert iteration according to some embodiments. FIG. 4 represents a training iteration for a certain reward function with set parameters. Training is performed until the model converges. At line 3, the language model (represented as π) generates a plurality of responses y to a query x. At line 4, rewards are generated for each of the responses. At line 5, the responses are resampled according to their rewards. At line 7, the newly sampled dataset is generated based on the sampling. At line 8, supervised fine-tuning is used to train the language model. This process is repeated until it converges. This process may be considered an inner training loop that is performed between reward parameter updates (i.e., curriculum steps).

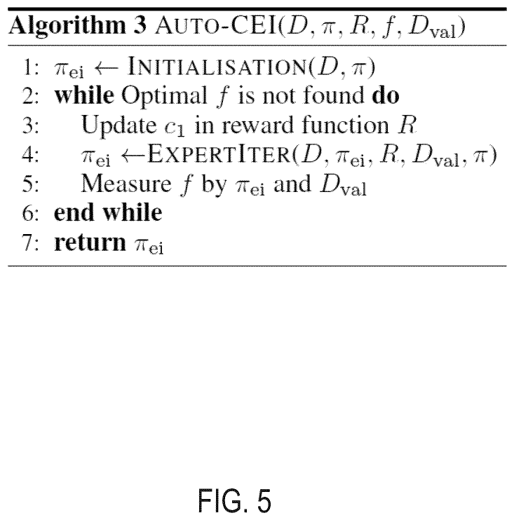

FIG. 5 is an automatic curriculum algorithm according to some embodiments. A language model (represented as π) is initialized at line 1. At line 3, hyperparameter c₁ is updated in the reward function. At line 4, the language model is trained via expert iteration as describe in FIG. 4. At line 5, the objective function ƒ (e.g., equation (1)) is measured to determine if it has been met. If not, then the process repeats until it converges. The algorithms for FIGS. 4-5 represent an embodiment as in framework 100.

### Computer and Network Environment

FIG. 6A is a simplified diagram illustrating a computing device implementing the language model training framework described in FIGS. 1-5, according to one embodiment described herein. As shown in FIG. 6A, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In another embodiment, processor 610 may comprise multiple microprocessors and/or memory 620 may comprise multiple registers and/or other memory elements such that processor 610 and/or memory 620 may be arranged in the form of a hardware-based neural network, as further described in FIG. 6B.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for LLM training module 630 that may be used to implement and/or emulate the systems and models, and/or to implement any of the methods described further herein. LLM training module 630 may receive input 640 such as an input training data (e.g., queries and responses) via the data interface 615 and generate an output 650 which may be a response.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as a query, from a user via the user interface.

In some embodiments, the LLM training module 630 is configured to train a language model and perform inference as described in FIGS. 1-5. The LLM training module 630 may further include expert iteration submodule 631 configured to perform training with resampled training data as described in FIGS. 1 and 4. The LLM training module 630 may further include curriculum submodule 632 configured to perform curriculum training including updating reward parameters as described in FIGS. 1-3 and 5. The LLM training module 630 may further include inference submodule 633 configured to perform inference using a trained language model. In some embodiments inference submodule 633 may receive queries and provide responses generated by the trained language model.

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6B is a simplified diagram illustrating the neural network structure implementing the LLM training module 630 described in FIG. 6A, according to some embodiments. In some embodiments, the LLM training module 630 and/or one or more of its submodules 631-633 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as a query. The number of nodes (neurons) in the input layer 641 may be determined by the dimensionality of the input data (e.g., the length of a vector of the query). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6A, the LLM training module 630 receives an input 640 of a query and transforms the input into an output 650 of a response. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LLM training module 630 and/or one or more of its submodules 631-633 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a transformer-based LLM, and/or the like.

In one embodiment, the LLM training module 630 and its submodules 631-633 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110) may receive a natural language input (such as a question) and generate a natural language output (such as an answer to the question).

In one embodiment, the LLM training module 630 and its submodules 631-633 may be implemented by hardware, software and/or a combination thereof. For example, the LLM training module 630 and its submodules 631-633 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

For example, to deploy the LLM training module 630 and its submodules 631-633 and/or any other neural network models such as _ described in FIG. _ onto hardware platform 660, the neural network based modules 630 and its submodules 631-633 may be optimized for deployment by converting it to a suitable format, such as ONNX or TensorRT, to improve performance and compatibility. Next, depending on the size and workload requirements for modules 630 and its submodules 631-633, hardware types may be chosen for deployment, e.g., processing capacity, GPU memory size, and/or the like. Frameworks and drivers for the chosen hardware 660 frameworks and drivers may thus be installed, such as PyTorch, TensorFlow, or CUDA, to support the hardware platform 660. Then, weights and parameters of the LLM training module 630 and its submodules 631-633 may be loaded to the hardware 660. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the LLM training module 630 and its submodules 631-633 may be deployed as a service, then they may be integrated with an API endpoint, using tools like Flask, FastAPI, or a cloud platform serverless services, and is accessible by a remote user via a network.

In another embodiment, some or all of layers 641, 642, 643 and/or neurons 642, 645, 646, and operations there between such as activations 661, 662, and/or the like, of the LLM training module 630 and its submodules 631-633 may be realized via one or more ASICs. For example, each neuron 642, 645 and 646 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LLM training module 630 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LLM training module 630 and one or more of its submodules 631-633 may be trained by iteratively updating the underlying parameters (e.g., weights 651, 652, etc., bias parameters and/or coefficients in the activation functions 661, 662 associated with neurons) of the neural network based on a loss function. For example, during forward propagation, the training data such as queries and responses are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding ground truth response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

In one embodiment, the neural network based LLM training module 630 and one or more of its submodules 631-633 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

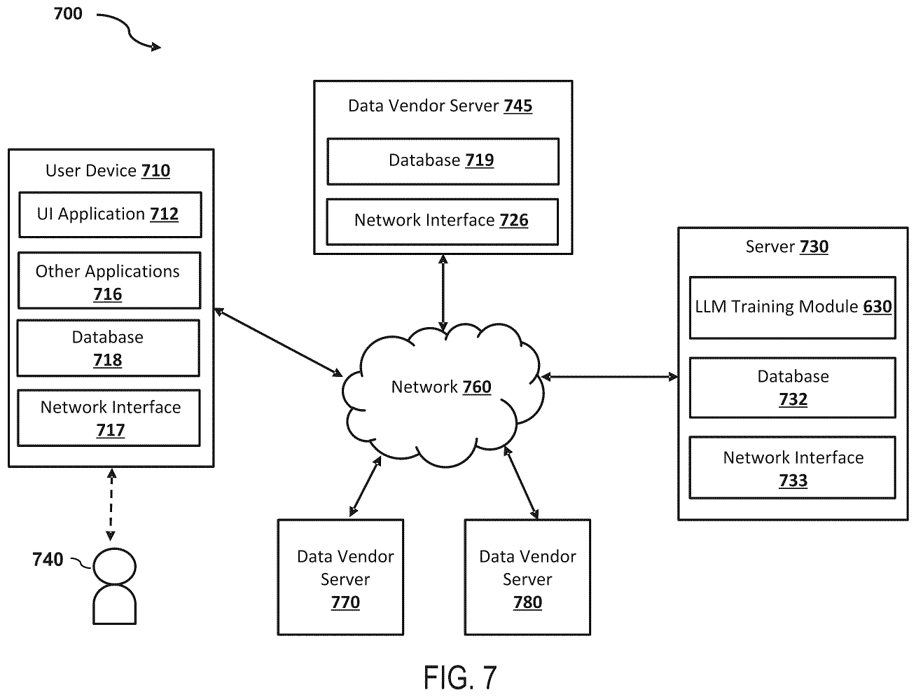

In some embodiments, LLM training module 630 and its submodules 631-633 may be housed at a centralized server (e.g., computing device 600) or one or more distributed servers. For example, one or more of LLM training module 630 and its submodules 631-633 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen queries.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in language models.

FIG. 7 is a simplified block diagram of a networked system 700 suitable for implementing the language model training framework described in FIGS. 1-6B and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 600 described in FIG. 6A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating a response from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the LLM training module 630 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which LLM training module 630 may generate a response via the process described in FIGS. 1-6. The LLM training module 630 may thus cause a display of a response at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view responses.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including queries and responses to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the LLM training module 630 and its submodules described in FIG. 6A. In some implementations, LLM training module 630 may receive data from database 719 at the data vendor server 745 via the network 760 to generate responses. The generated responses may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the LLM training module 630. In one implementation, the database 732 may store previously generated responses, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

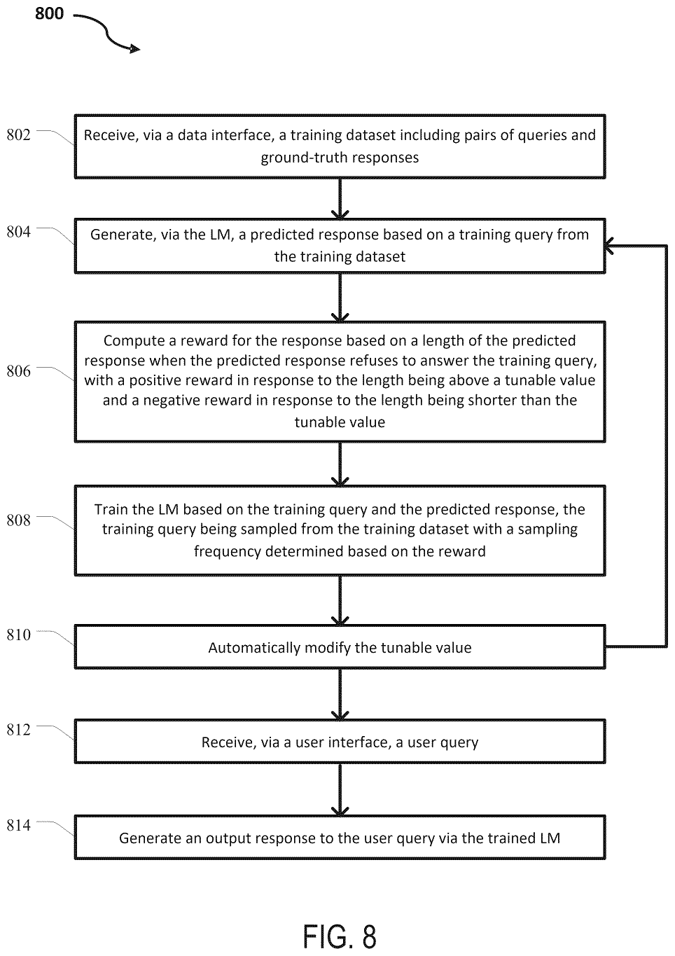

FIG. 8 is an example logic flow diagram illustrating a method of training a neural network based language model based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the LLM training module 630 (e.g., FIGS. 6A and 7) that performs language model training and inference.

In some embodiments, method 800 is performed by a system such as computing device 600, user device 710, server 730, or another device or combination of devices. Inputs (e.g., queries) may be received via a data interface such as data interface 615, network interface 717, network interface 733, or via a data interface that is integrated with a device. For example UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, a system receives, via a data interface, a training dataset including pairs of queries and ground-truth responses.

At step 804, the system generates, via a neural network based language model (LM), a predicted response based on a training query from the training dataset.

At step 806, the system computes a reward for the response based on a length of the predicted response when the predicted response refuses to answer the training query, with a positive reward in response to the length being above a tunable value and a negative reward in response to the length being shorter than the tunable value. In some embodiments, the length is a number of reasoning steps. In some embodiments, computing the reward for the response based on the length of the predicted response includes computing the reward according to a curve (e.g., the curve in FIG. 3), wherein the curve has a highest rate of change when the length is the same as the tunable value.

At step 808, the system trains the LM based on the training query and the predicted response, the training query being sampled from the training dataset with a sampling frequency determined based on the reward.

At step 810, the system automatically modifies the tunable value. After modifying the tunable value, the system may return to step 804 to repeat the training iteration with the modified tunable value. One training is completed, the system may continue to step 812. In some embodiments, the system is completed training when the tunable value reaches a maximum value. In some embodiments, the system is completed training when the objective function reaches the optimal value. In some embodiments, automatically modifying the tunable value includes incrementally adjusting the tunable value to maximize an objective function (e.g., equation (1)) which balances a correctness of non-refusal responses with a proportion of refusal responses. In some embodiments, incrementally adjusting is performed using a step size proportional to a standard deviation of length of responses generated by the LM (e.g., as in equation (2)). In some embodiments, the step size has a predetermined maximum value (e.g., as in equation (2)). In some embodiments, the tunable value is constrained to be less than or equal to a mean length of responses generated by the LM plus double a standard deviation of length of responses generated by the LM.

At step 812, the system receives, via a user interface, a user query.

At step 814, the system generates an output response to the user query via the trained LM.

In some embodiments, method 800 is applicable in a variety of applications. For example, a task request received by a neural network model (e.g., language model 106) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 800, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

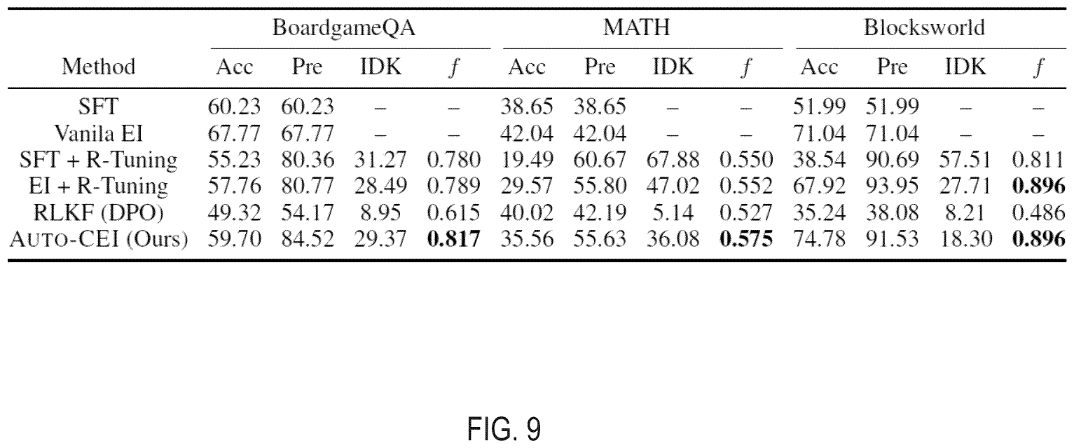

FIGS. 9-13 provide charts illustrating exemplary performance of different embodiments described herein. Models trained via embodiments described herein are referred to as “Auto-CEI.” To demonstrate the effectiveness of AUTO-CEI in reasoning tasks, BoardgameQA (Kazemi et al., Boardgameqa: A dataset for natural language reasoning with contradictory information. Advances in Neural Information Processing Systems, 36, 2024), MATH (Hendrycks et al., Measuring mathematical problem solving with the MATH dataset. In Thirty-fifth Conference on Neural Information Processing Systems Datasets and Benchmarks Track (Round 2), 2021), and Blocksworld (Valmeekam et al., On the planning abilities of large language models—a critical investigation. Advances in Neural Information Processing Systems, 36:75993-76005, 2023) were selected as benchmarks, spanning from logical and mathematical reasoning to planning. They have various domains and complexities.

BoardgameQA is one of the latest benchmarks for logical reasoning. The data is synthesized from formal logical reasoning rules and clauses. The problem provides a self-contained context, pieces of evidence, reasoning rules, and questions. Given the evidence and reasoning rules, LLM must decide if the queried clause is true, false, or unknown. Moreover, BoardgameQA has cases where some evidence might contradict others. To deal with this case, BoardgameQA also provides preferences among the reasoning rules, meaning that the conclusions drawn from the preferred rules have higher priority. In addition, since BoardgameQA does not provide CoT data for unknown questions, GPT-4 generates CoT reasoning trajectories for unknown problems for the training dataset. Thus, the training data is consistent.

MATH is a challenging mathematical reasoning benchmark, including advanced-level algebra and geometry. In each of the problems, the necessary evidence is provided in the context, and the LLM is required to learn correct mathematical theorems and rules to connect the pieces of evidence in the given problem and draw conclusions. It typically requires long reasoning steps in which each mathematical theorem and rule is correctly applied to get the correct answers.

Blocksworld is a symbolic planning problem. It defines a domain with a few blocks in different colors. The problem requires the LLM to rearrange the blocks step-by-step and make the configuration of the blocks satisfy some preferred constraints. Concretely, it requires the LLM to output a sequence of pick and place behaviors, which transform the current configuration of blocks to the goal configuration. Blocksworld has been proved to be NP-hard in finding optimal (i.e., shortest) planning trajectories (Gupta & Nau, On the complexity of blocks-world planning. Artificial intelligence, 56(2-3):223-254, 1992), while suboptimal policies might be easier to learn.

To validate the effectiveness of AUTO-CEI, extensive experiments were run comparing it against multiple baselines: (1) SFT. Supervised fine-tuning was performed on the original training dataset D and use the overall accuracy as a reference metric. (2) Vanilla EI. As noted by Havrilla et al. (Teaching large language models to reason with reinforcement learning. arXiv preprint arXiv:2403.04642, 2024), Expert Iteration achieves strong results in enhancing reasoning capabilities. Expert Iteration was applied to improve LLM reasoning, evaluating its performance by retaining only correct and assertive answers during the iteration process. (3) SFT+R-Tuning (Zhang et al., R-tuning: Teaching large language models to refuse unknown questions. arXiv preprint arXiv:2311.09677, 2023). This is an SFT-based post-training method for hallucination mitigation. (4) EI+R-Tuning. This baseline uses Vanilla Expert Iteration to boost the performance of LLM reasoning first and then uses R-Tuning for post-training. (5) RLKF (DPO). Reinforcement Learning from Knowledge Feedback (RLKF) (Xu et al., Rejection improves reliability: Training LLMs to refuse unknown questions using RL from knowledge feedback. In First Conference on Language Modeling, 2024) is an RL-based post-training method for hallucination mitigation. It aligns the LLM's behaviors according to the consistency and correctness of LLM's sampled responses: it teaches LLM to respond assertively if its responses are correct and consistent and acknowledges “I don't know” if its responses are mainly wrong or inconsistent. A DPO version of this method was implemented.

Metrics used in experiments include LLM's responses' overall accuracy, precision, and refusal rate (refusal rate) is measured. The overall accuracy measures the overall performance of LLM in a specific reasoning task. A higher accuracy means the LLM can solve more problems. Accuracy is computed by

$$Acc = \frac{Number of correct responses}{Number of all responses} .$$

The precision measures the accuracy of LLM when it is willing to answer the questions assertively. It reflects the overall reliability of LLM reasoning. Precision is computed by

$$PPre = \frac{Number of correct responses}{Number of all responses - Num of IDK )} .$$

In addition, the hallucination (error) rate refers to

$$Error = \frac{Number of non - refusal but incorrect responses}{Number of all responses - Number of IDK responses} .$$

The refusal rate measures how conservative the LLM policy is. It is computed by

$$PIDK = \frac{Number of refusal responses}{Number of all responses} .$$

A good LLM policy should have reasonable precision and refusal rate balance, i.e., a high precision and a reasonable refusal rate according to the difficulty of the task.

FIG. 9 shows the main result, where AUTO-CEI produces high precision (Pre) and keeps a reasonably lower refusal rate (IDK) across all tasks. It also has the highest objective function value f defined by equation (2) (λ=0.2).

In the experiments, the Vanila EI produced higher overall accuracy than SFT in all tasks, which indicates the overall capacity of LLM in reasoning is improved. This improvement is because EI helps LLM to sample various trajectories and collect those who draw a correct solution and learn those solutions; for the next iteration of EI, it samples more trajectories near those correct trajectories and keeps collecting and learning. Overtime, LLM learns to start from various trajectories and still gets to the correct solution, even though some might be suboptimal. Thus, it becomes more robust to the randomness in token sampling when generating responses and the resulting compounding errors.

SFT+R-Tuning and EI+R-Tuning all show the trend of over-conservativeness (i.e., laziness). The results of both baselines have a relatively high refusal rate (IDK) and lower overall accuracy. The low overall accuracy indicates that LLM's capacity has been limited, and LLM produces refusal responses to many problems that lie within the LLM's capability.

RLKF performs well for short, knowledge-grounded arithmetic problems. However, for reasoning problems, the responses generally become much longer for more complex questions. This causes a few additional issues for RLKF techniques. First, the LLM finds it hard to distinguish the correct chosen/rejected responses given the long response length if the dataset is not very large; thus, the reward accuracy is relatively low (it only has 30% accuracy for Blocksworld and 70% for BoardgameQA and MATH). Second, the original strategy of reward shaping greedily maximizes the reward for correct answers and minimizes incorrect or refusal responses. As such, the LLM will be over-assertive. As it greedily imitates the optimal responses guided by the inaccurate reward, it will suffer more from the compounding error when facing the unseen context of the reasoning problems, thus degrading its performance.

The result shows that the overall accuracy of AUTO-CEI is higher than SFT+R-Tuning. Since the method initializes its optimization using SFT+R-Tuning, this result indicates that AUTO-CEI improves LLM's reasoning capacities. It is because AUTO-CEI gradually adjusts the curriculum to encourage LLM to solve more problems within its capacities and only accepts refusal responses after sufficient reasoning attempts. It thus avoids the LLM's laziness in easy problems and improves the robustness of the LLM's problem-solving when it samples suboptimal trajectories.

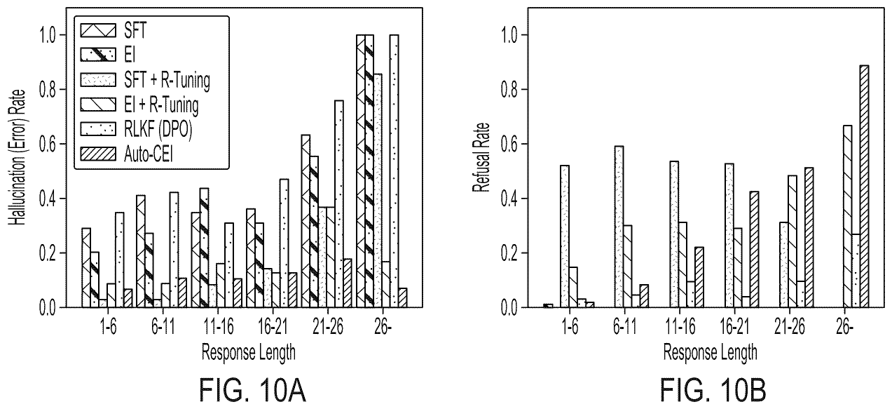

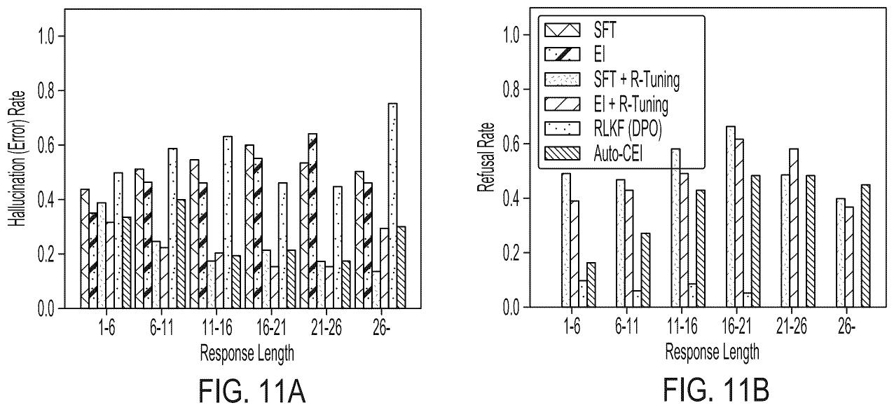

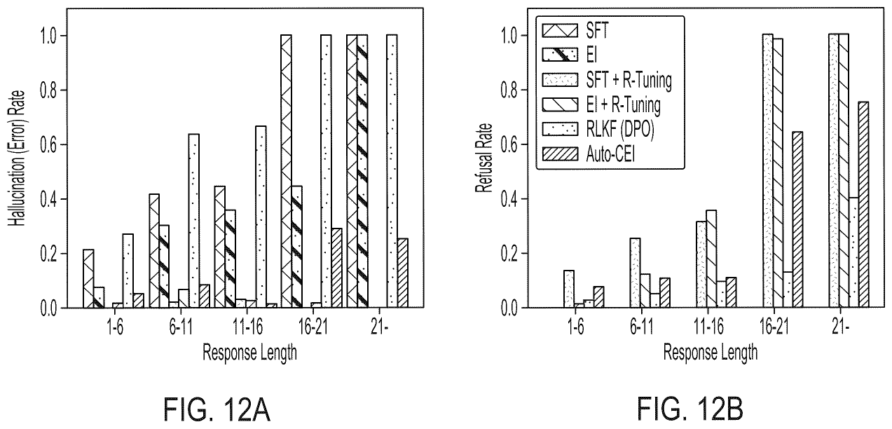

FIGS. 10A and 10B show the error and refusal rate (hallucination/IDK) according to the response length for BoardgameQA. FIGS. 11A and 11B show the error and refusal rate according to the response length for MATH. FIGS. 12A and 12B show the error and refusal rate according to the response length for Blocksworld. The error rate of SFT and EI grows exponentially with the increase in response length. Auto-CEI estimates LLM's limit in reasoning and produces the best alignment between its behaviors and its limit. The error (hallucination) rate and refusal rate (IDK) are compared according to the response length. On the other hand, AUTO-CEI has a relatively uniform low rate of hallucination for different response lengths, and its refusal rate (refusal rate) grows according to the error rate of SFT/EI, as is ideally expected. This result indicates that AUTO-CEI is indeed able to estimate LLM's current capability limit and is further capable of reaching a reasonable alignment between its assertive and conservative behaviors according to its limit. It thus behaves assertively for problems within its limit (low refusal rate for short reasoning length) and conservatively for problems beyond its limit (high refusal rate for long reasoning length). Overall, it produces reliable reasoning while simultaneously maintaining maximum reasoning ability.

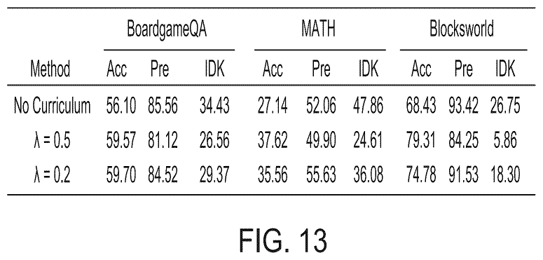

FIG. 13 shows an ablation study where Acc: accuracy (%); Pre: precision (%); and IDK: refusal rate (%). This study was conducted to verify the effectiveness of the solution design choices and further discusses the underlying assumptions.

The hyperparameter λ decides the optimal objective function and when to stop the optimization. A higher λ will try to minimize the refusal rate (refusal rate) and thus make the LLM more assertive. The lower λ will try to focus on maximizing precision and tends to keep a higher refusal rate, making the LLM policy more conservative. The λ does not affect the overall training process in AUTO-CEI, and the decision of the hyperparameter is mainly determined by the user's demand. Empirically, λ=0.2 has a reasonable balance between the precision and refusal rate. In practice, it is suggested the user start by λ=0.2 and further adjust the parameter according to the demands. For example, a lower λ would be preferred in highly risky tasks, whereas a higher λ is better for training search heuristics that require more assertive behaviors, a higher λ is better.

The curriculum is designed to push the limit of LLM reasoning, thus achieving a good alignment of its behaviors and maximizing its reasoning ability simultaneously. The result in FIG. 13 (No Curriculum) shows that LLM converge to a suboptimal point where its overall accuracy is lower and its refusal rate is higher. In addition, there might be a chance that LLM directly reaches the optimal f after one curriculum with some other choices of λ. However, as discussed previously, the choice of λ is determined by the user's demand, and the optimization conducted by the curriculum should be able to find the optimal point specified by different λ.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a neural network based language model (LM), comprising:
receiving, via a data interface, a training dataset including pairs of queries and ground-truth responses;
performing a training iteration including:
generating, via the LM, a predicted response based on a training query from the training dataset,
computing a reward for the response based on a length of the predicted response when the predicted response refuses to answer the training query, with a positive reward in response to the length being above a tunable value and a negative reward in response to the length being shorter than the tunable value, and
training the LM based on the training query and the predicted response, the training query being sampled from the training dataset with a sampling frequency determined based on the reward;
automatically modifying the tunable value;
repeating the training iteration with the modified tunable value;
receiving, via a user interface, a user query; and
generating an output response to the user query via the trained LM.

2. The method of claim 1, wherein the automatically modifying the tunable value includes:
incrementally adjusting the tunable value to maximize an objective function which balances a correctness of non-refusal responses with a proportion of refusal responses.

3. The method of claim 2, wherein the incrementally adjusting is performed using a step size proportional to a standard deviation of length of responses generated by the LM.

4. The method of claim 3, wherein the step size has a predetermined maximum value.

5. The method of claim 1, wherein the tunable value is constrained to be less than or equal to a mean length of responses generated by the LM plus double a standard deviation of length of responses generated by the LM.

6. The method of claim 1, wherein the length is a number of reasoning steps.

7. The method of claim 1, wherein computing the reward for the response based on the length of the predicted response includes:
computing the reward according to a curve, wherein the curve has a highest rate of change when the length is the same as the tunable value.

8. A system for training a neural network based language model (LM), the system comprising:
a memory that stores the LM and a plurality of processor executable instructions;
a communication interface that receives a training dataset including pairs of queries and ground-truth responses; and
one or more hardware processors that read and execute the plurality of processor-executable instructions from the memory to perform operations comprising:
performing a training iteration including:
generating, via the LM, a predicted response based on a training query from the training dataset,
computing a reward for the response based on a length of the predicted response when the predicted response refuses to answer the training query, with a positive reward in response to the length being above a tunable value and a negative reward in response to the length being shorter than the tunable value, and
training the LM based on the training query and the predicted response, the training query being sampled from the training dataset with a sampling frequency determined based on the reward;
automatically modifying the tunable value;
repeating the training iteration with the modified tunable value;
receiving, via a user interface, a user query; and
generating an output response to the user query via the trained LM.

9. The system of claim 8, wherein the automatically modifying the tunable value includes:
incrementally adjusting the tunable value to maximize an objective function which balances a correctness of non-refusal responses with a proportion of refusal responses.

10. The system of claim 9, wherein the incrementally adjusting is performed using a step size proportional to a standard deviation of length of responses generated by the LM.

11. The system of claim 10, wherein the step size has a predetermined maximum value.

12. The system of claim 8, wherein the tunable value is constrained to be less than or equal to a mean length of responses generated by the LM plus double a standard deviation of length of responses generated by the LM.

13. The system of claim 8, wherein the length is a number of reasoning steps.

14. The system of claim 8, wherein computing the reward for the response based on the length of the predicted response includes:
computing the reward according to a curve, wherein the curve has a highest rate of change when the length is the same as the tunable value.

15. A non-transitory machine-readable medium comprising a plurality of machine-executable instructions which, when executed by one or more processors, are adapted to cause the one or more processors to perform operations comprising:
receiving, via a data interface, a training dataset including pairs of queries and ground-truth responses;
performing a training iteration including:
generating, via a neural network based language model (LM), a predicted response based on a training query from the training dataset,
computing a reward for the response based on a length of the predicted response when the predicted response refuses to answer the training query, with a positive reward in response to the length being above a tunable value and a negative reward in response to the length being shorter than the tunable value, and
training the LM based on the training query and the predicted response, the training query being sampled from the training dataset with a sampling frequency determined based on the reward;
automatically modifying the tunable value;
repeating the training iteration with the modified tunable value;
receiving, via a user interface, a user query; and
generating an output response to the user query via the trained LM.

16. The non-transitory machine-readable medium of claim 15, wherein the automatically modifying the tunable value includes:
incrementally adjusting the tunable value to maximize an objective function which balances a correctness of non-refusal responses with a proportion of refusal responses.

17. The non-transitory machine-readable medium of claim 16, wherein the incrementally adjusting is performed using a step size proportional to a standard deviation of length of responses generated by the LM.

18. The non-transitory machine-readable medium of claim 17, wherein the step size has a predetermined maximum value.

19. The non-transitory machine-readable medium of claim 15, wherein the tunable value is constrained to be less than or equal to a mean length of responses generated by the LM plus double a standard deviation of length of responses generated by the LM.

20. The non-transitory machine-readable medium of claim 15, wherein the length is a number of reasoning steps.
